(19) United States
(12) Patent Application Publication
(10) Pub. No.: US 2003/0018696 A1
(43) Pub. Date: Jan. 23, 2003

(54) Method for executing multi-system aware applications

(76) Inventors: Humberto A. Sanchez II, Ft Collins, CO (US); George Williams JR., Fort Collins, CO (US); C. Scot Greenidge, Loveland, CO (US); Douglas P. Drees, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/852,894

(22) Filed: May 10, 2001

(51) Int. Cl. G06F 15/16

(52) U.S. Cl. 709/201; 709/226

(57) ABSTRACT

By setting up a single multi-system management environment, a ServiceControl Manager provides a simple means to integrate both SSA management applications and MSA management applications into the multi-system environment. MSA applications may be started by a user using either command line interface (CLI) or graphical user interface (GUI). Either from CLI or from GUI, the method for MSA applications includes selecting an MSA tool by a user, establishing a target node list that contains nodes on which the tool may run, and passing the target node list as environment variables. The environment variables are then passed to the MSA applications that use the node list to restrict the user access to these nodes.

### TECHNICAL FIELD

The present invention relates to system administration management, and, in particular, to ServiceControl Manager modules.

### BACKGROUND

Computer systems are increasingly becoming commonplace in homes and businesses throughout the world. As the number of computer systems increases, more and more computer systems are becoming interconnected via networks. These networks include local area networks (LANs). LANs also frequently have an interface to other networks, such as the Internet, and this interface needs to be monitored and controlled by network management on the LAN.

One concern encountered with networks is referred to as network management. Network management refers to monitoring and controlling of the network devices and includes the ability for an individual, typically referred to as an administrative user, to be able to access, monitor, and control the devices that are part of the network, or access, monitor, and control the devices that are part of the network coupled to other computer systems. Such access, monitoring, and control often include the ability to check the operating status of devices, receive error information for devices, change configuration values, and perform other management functions. As the size of networks increases, so too does the need for network management.

The operating system of most computers provides an administration tool or a system administration manager for invoking and performing system management tasks. The hardware of a computer system, the various facilities included within the operating system, such as the file system facility, the print spooling facility, and the networking facility, as well as the operating system itself must all be managed. This means that computer systems require some involvement by a human user or a manager of the computer system for such operations as specifying certain configuration parameters, monitoring ongoing activity, or troubleshooting some problem that has arisen. These management or administration tasks can be performed manually in many operating systems, for example, by a risk control manager, via direct manipulation of configuration files or direct invocation of specific administration utility programs. But in most modem operating systems, an easy to use, interactive software program is typically provided that hides the details of the file formats and the utility program syntax, while providing a higher level presentation for the system administrator.

The System Administration Manager (SAM) is a system manager used by Hewlett-Packard Co's version (HP-UX) for Unix system administration management. Contemporary versions of SAM include a graphical user interface (GUI) arranged to make as user-friendly as possible the various system administration activities that are available with SAM. In a conventional Unix system, the user performing such administration activities must be a root user, referred to as a super-user. The super-user has unlimited privileges with regard to the reading and writing of files, and with regard to what commands he or she may execute in the system. SAM allows the super-user to perform the most important tasks in a system administrator's job by filling out templates, rather than using command line interfaces. SAM allows system administrators to perform basic administrative tasks, such as adding new users, installing new printers, assigning administration privileges, and reconfiguring a kernel with a new print driver, quickly, easily and, most importantly, safely.

Another system manager, referred to as a Software Distributor (SD), is the HP-UX administration tool-set used to deliver and maintain HP-UX operating systems and layered software applications. SD allows central IT departments to control an associated software environment. It also improves administrator productivity by automating software distribution.

SAM management applications can only operate on the system on which the applications are running, while SD/UX applications have the ability to operate on multiple nodes. HP's OpenView Network Node Manager provides a simple means to integrate single-system aware (SSA) applications such as SAM, but a completely different and more complex means for integrating multi-system aware (MSA) applications such as SD/UX. For example, since Open View can only run a tool on a remote machine as root, integrating SD/UX into OpenView Network Node Manager requires a complex process for implementing a number of changes by a whole project team.

There are other similar distributed management systems such as IBM's Tivoli product that behave similarly to OpenView by providing a very complex mechanism for integrating multi-system aware (MSA) management applications. There is a need for a simple mechanism to integrate SSA applications and MSA applications.

### SUMMARY

A ServiceControl Manager (SCM) module provides a simple means to integrate both single system aware (SSA) management applications and multi-system aware (MSA) management applications into a single multi-system management environment.

MSA applications may be started by a user using either command line interface (CLI) or graphical user interface (GUI). Using GUI, there may be two different ways of executing MSA applications on a remote node, either from a tool view menu or from a node view menu.

Either from CLI or from GUI, the method for MSA applications includes selecting an MSA tool by a user, establishing a target node list that contains nodes on which the tool may run, and passing the target node list as environment variables. The environment variables are then passed to the MSA applications that use the node list to restrict the user access to these nodes.

### DESCRIPTION OF THE DRAWINGS

The detailed description refers to the following drawings, in which like numbers refer to like elements, and in which:

FIG. 1(a) illustrates a computer network system with which the present invention may be used;

FIGS. 1(b) and 1(c) compare single-system aware tools and multi-system aware tools;

FIG. 2 illustrates the relationships between the user, role, node, tool and authorization objects;

FIG. 3(a) is a block diagram of an exemplary server used to implement the present invention;

FIGS. 3(b) and 3(c) shows a tool view menu and a node view menu, respectively;

FIG. 4 illustrates a method for executing MSA applications in the SCM module using a command line interface;

FIG. 5 illustrates a method for executing MSA applications using a graphical user interface from a tool view menu; and

FIG. 6 illustrates a method for executing MSA applications using a graphical user interface from a node view menu.

### DETAILED DESCRIPTION

A ServiceControl Manager (SCM) module multiplies system administration effectiveness by distributing the effects of existing tools efficiently across managed servers. The phrase “ServiceControl Manager” is intended as a label only, and different labels can be used to describe modules or other entities having the same or similar functions.

In the SCM domain, the managed servers (systems) are referred to as “managed nodes” or simply as “nodes”. SCM node groups are collections of nodes in the SCM module. They may have overlapping memberships, such that a single node may be a member of more than one group.

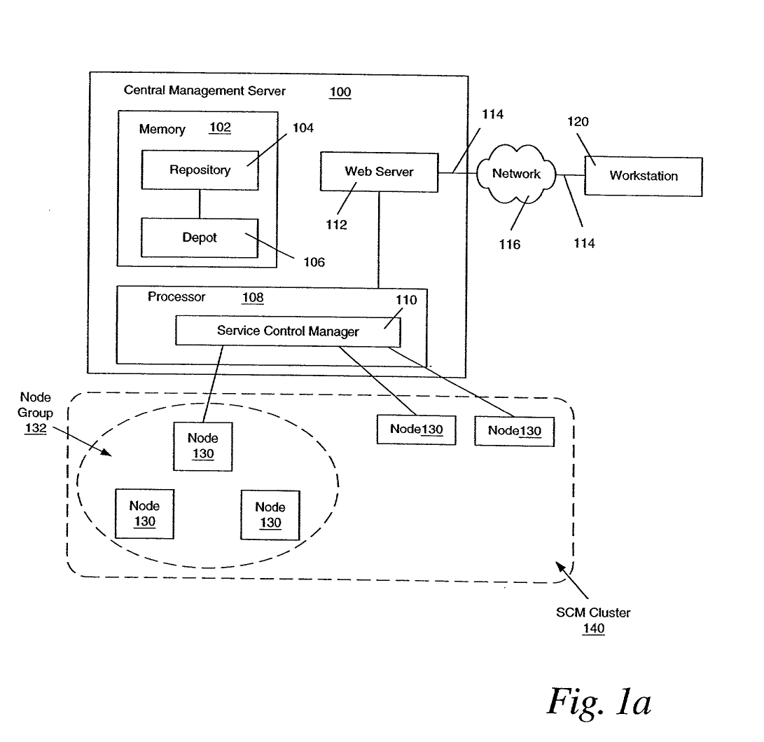

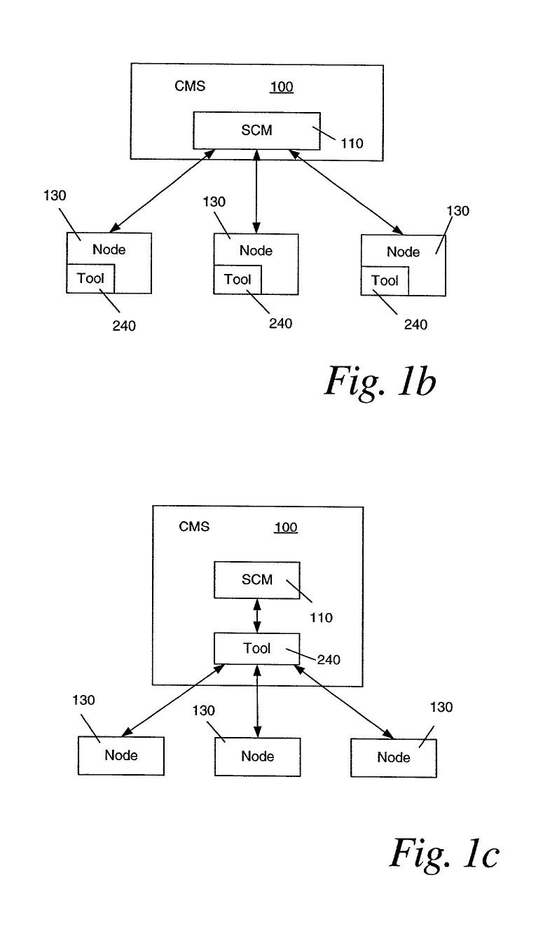

FIG. 1(a) illustrates a computer network system with which the present invention may be used. The network system includes an SCM 110 running on a Central Management Server (CMS) 100 and one or more nodes 130 or node groups 132 managed by the SCM 110. The one or more nodes 130 and node groups 132 make up an SCM cluster 140. For a more detailed description of an embodiment of SCM, see ServiceControl Manager Technical Reference HP® part number: B8339-90019, available from Hewlett-Packard Company, Palo Alto, Calif., which is incorporated herein by reference and which is also accessible at <http://www.software.hp.com/products/scmgr>.

The CMS 100 can be implemented with, for example, an HP-UX 11.x server running the SCM 110 software. The CMS 100 includes a memory 102, a secondary storage device (not shown), a processor 108, an input device (not shown), a display device (not shown), and an output device (not shown). The memory 102 may include computer readable media, RAM or similar types of memory, and it may store one or more applications for execution by processor 108, including the SCM 110 software. The secondary storage device may include computer readable media, a hard disk drive, floppy disk drive, CD-ROM drive, or other types of non-volatile data storage. The processor 108 executes the SCM software and other application(s), which are stored in memory or secondary storage, or received from the Internet or other network 116. The input device may include any device for entering data into the CMS 100, such as a keyboard, key pad, cursor-control device, touch-screen (possibly with a stylus), or microphone. The display device may include any type of device for presenting a visual image, such as, for example, a computer monitor, flat-screen display, or display panel. The output device may include any type of device for presenting data in hard copy format, such as a printer, and other types of output devices include speakers or any device for providing data in audio form. The CMS 100 can possibly include multiple input devices, output devices, and display devices.

The CMS 100 itself may be required to be a managed node, so that multi-system aware (MSA) tools may be invoked on the CMS. All other nodes 130 may need to be explicitly added to the SCM cluster 140. Alternatively, the CMS 100 may be part of the SCM cluster 140.

Generally, the SCM 110 supports managing a single SCM cluster 140 from a single CMS 100. All tasks performed on the SCM cluster 140 are initiated on the CMS 100 either directly or remotely, for example, by reaching the CMS 100 via a web connection 114. Therefore, the workstation 120 at which a user sits only needs a web connection 114 over a network 116, such as the Internet or other type of computer network, to the CMS 100 in order to perform tasks on the SCM cluster 140. The CMS 100 preferably also includes a centralized data repository 104 for the SCM cluster 140, a web server 112 that allows web access to the SCM 110 and a depot 106 that includes products used in the configuring of nodes 130. A user interface may only run on the CMS 100, and no other node 130 in the SCM module may execute remote tasks, access the repository 104, or any other SCM operations.

Although the CMS 100 is depicted with various components, one skilled in the art will appreciated that this server can contain additional or different components. In addition, although aspects of an implementation consistent with the present invention are described as being stored in memory, one skilled in the art will appreciated that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the CMS 100 to perform a particular method.

A central part of the SCM module 110 is the ability to execute various management commands or applications on the one or more nodes simultaneously. The commands or applications may need to be encapsulated with an SCM tool, which is typically used to copy files and/or execute commands on the target nodes 130. The SCM tool may run simple commands such as bdf (1) or mount (1M), launch single system interactive applications such as System Administration Manager (SAM) or Glance, launch multi-system aware applications such as Ignite/UX or Software Distributor (SD), or perform other functions. The tool may be defined using either an SCM tool definition language through command line interface (CLI) or an SCM-provided graphical user interface (GUI).

There are two general types of tools: single-system aware (SSA) tools and multi-system aware (MSA) tools. SSA tools, illustrated in FIG. 1(b), may run on a node 130 and may only affect the operation of that node 130. To run SSA tools on multiple target nodes 130, the SCM module 110 may execute the tools on each target node 130. In addition to executing commands or launching applications, SSA tools may copy files from the CMS 100 to the target nodes 130. Files may only be copied from the CMS 100 to the managed nodes 130 in this exemplary embodiment, not from the nodes 130 back to the CMS 100.

MSA tools, illustrated in FIG. 1(c), may run on a single node 130 but may be able to operate on multiple other nodes 130. MSA tools are applications that execute on a single node but can detect and contact other nodes to accomplish their work and this contact is out of the control of the SCM module 110. This type of application may need to have a list of nodes 130 passed as an argument at runtime. A node 130 where the application will execute may need to be specified at tool creation time, not at runtime. The target nodes 130 selected by the user may be passed to an MSA tool via MX₁₃TARGETS environment variables (described later). MSA tools may not copy files to either the manager node 100 or to the target nodes 130 in this exemplary embodiment. Therefore, an execution command string may be required for MSA tools.

An SCM user may be a user that is known to the SCM module 110 and has some privileges and/or management roles. An SCM role, which is an expression of intent and a collection of tools for accomplishing that intent, typically defines what the user is able to do on the associated nodes 130 or node groups 132, e.g., whether a user may run a tool on a node 130. Typically, in order to start the SCM module 110 or execute any SCM tools, the user may need to be added to the SCM module 110 and authorized either via the GUI or the command line interface (CLI). All SCM module 110 operations may be authorized based on the user's SCM authorization configuration, and/or whether or not the user has been granted SCM trusted user privilege.

The SCM user may, depending upon the roles assigned, manage systems via the SCM module 110. In addition, the user may examine an SCM log, and scan the group and role configurations. When the SCM user runs a tool, the result may be an SCM task. The SCM module 110 typically assigns a task identifier for every task after it has been defined and before it is run on any target nodes 130. This identifier may be used to track the task and to look up information later about the task in an SCM central log.

An SCM trusted user is an SCM user responsible for the configuration and general administration of the SCM cluster 140. The trusted user is typically a manager or a supervisor of a group of administrators whom a company trusts, or other trusted individual. The capabilities of the trusted user include, for example, one or more of the following: creating or modifying a user's security profile; adding, modifying or deleting a node or node group; tool modification; and tool authorization. The granting of these privileges implies a trust that the user is responsible for configuring and maintaining the overall structure of the SCM module 110.

An SCM authorization model supports the notion of assigning to users the ability to run a set of tools on a set of nodes. An authorization object is an association that links a user to a role on either a node or a node group. Each tool may belong to one or more roles. When users are given the authority to perform some limited set of functionality on one or more nodes, the authorization is done based upon roles and not on tools. The role allows the sum total of functionality represented by all the tools to be divided into logical sets that correspond to the responsibilities that would be given to the various administrators. Accordingly, there are different roles that may be configured and assigned with authorization. For example, a backup administrator with a “backup” role may contain tools that perform backups, manage scheduled backups, view backup status, and other backup functions. On the other hand, a database administrator with a “database” role may have a different set of tools. When a user attempts to run a tool on a node, the user may need to be checked to determine if the user is authorized to fulfill a certain role on the node and if that tool contains the role. Once a user is assigned an authorization, the user gains access to any newly created tools that contain the role. In the example given above, the backup administrator may be assigned the “backup” role for a group of systems that run a specific application. When new backup tools are created and added to the “backup” role, the backup administrator immediately gains access to the new tools on the systems.

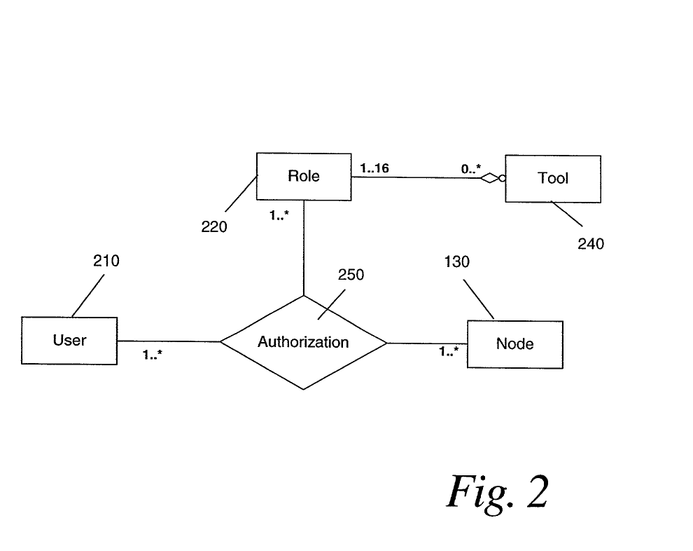

FIG. 2 illustrates the relationships between user 210, role 220, node 130, tool 240, and authorization 250 objects. User objects 210 represent users 210, role objects 220 represent roles 220, node objects 130 represent nodes 130, tool objects 240 represent tools 240, and authorization objects 250 represent authorizations 250. However, for the purpose of this application, these terms are used interchangeably. Each authorization object 250 links a single user object 210 to a single role object 220 and to a single node object 130 (or a node group object 132). Each role object 220 may correspond to zero or more tool objects 240, and each tool object 240 may correspond to one or more role objects 220. Each user object 210 may be assigned multiple authorizations 250, as may each role object 220 and each node object 130. For example, Role 1 may contain Tools 1-N, and User 1 may be assigned Roles 1-M by the authorization model on Node 1. Consequently, User 1 may run Tools 1-N on Node 1, based upon the role assigned, Role 1.

Table 1 illustrates an example of a data structure for assigning tools 240 and commands specified in the tools 240 to different roles 220. Table 2 illustrates an example of a data structure for assigning the roles 220 to different users 210 on different nodes 130.

TABLE 1

| | | Commands and |
|---|---|---|
| Roles | Tools | Applications |
| Role 1 | Tools 1-N | Commands 1-L |
| . . . | . . . | . . . |
| Role n | Tools 1-Nn | Commands 1-Ln |

TABLE 2

| Users | Assigned Roles | Assigned Nodes |
|---|---|---|
| User 1 | Roles 1-M | Nodes 1-x |
| . . . | . . . | . . . |
| User n | Roles 1-M | Nodes 1-x |

Although FIG. 2 shows a node authorization, a similar structure exists for a node group 132 authorization. The SCM authorization model may be deployed by using node group 132 authorizations more often than node 130 authorizations. This model makes adding new nodes simpler because by adding a node 130 to an existing group 132, any authorizations associated with the group 132 may be inherited at runtime by the node 130.

The authorization model for determining if a user may execute a tool 240 on a set of nodes 130 may be defined by an “all or none” model. Therefore, the user 210 must have a valid authorization association for each target node 130 to execute the tool 240. If authorization does not exist for even one of the nodes 130, the tool execution fails.

The SCM cluster 140 may also include security features to secure transactions that transmit across the network. All network transactions may be digitally signed using a public or private key pair. The recipient of network transmissions may be assured of who the transmission came from and that the data was not altered in the transmission. A hostile party on the network may be able view the transactions, but may not counterfeit or alter them.

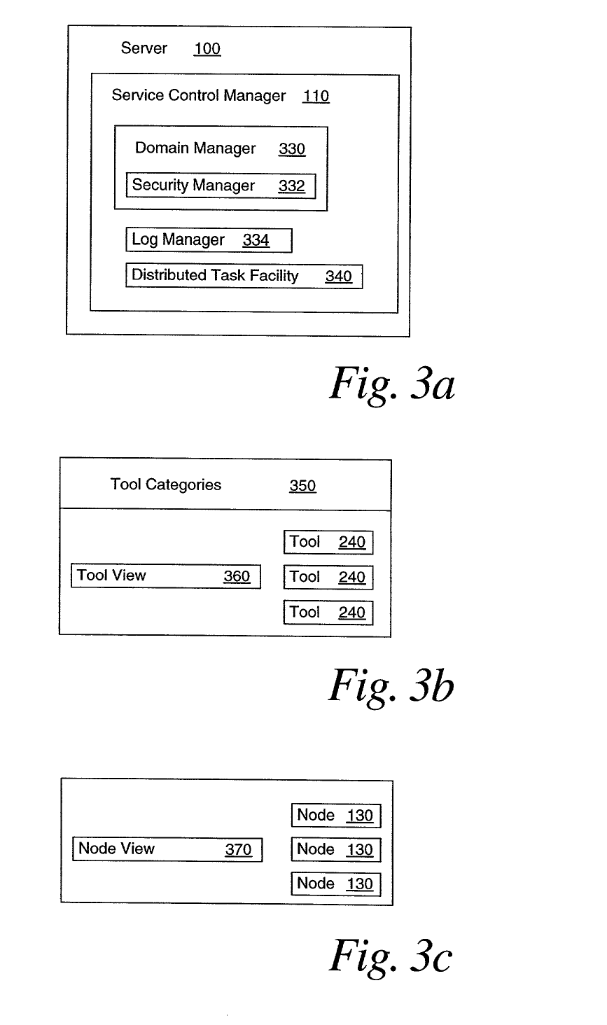

Referring to FIG. 3(a), the CMS 100 may include a domain manager 330, a log manager 334, and a distributed task facility (DTF) 240. The domain manager 330 is the “brain” of SCM module 110 and may be connected to the repository 104 for storage of the definitions of all the objects.

The DTF 340 may execute tasks by passing the task definitions and information to agents running on the managed nodes 130. The DTF 340 is the “heart” of all task execution activity in that all of the execution steps must go through the DTF 340. The DTF 340 typically obtains an authorized runnable tool from a client, distributes the tool execution across multiple nodes 130, and returns execution results to the clients and to the user 210.

An integral part of the SCM functionality may be the ability to record and maintain a history of events, by logging both SCM configuration changes and task execution events through the log manager 334. The log manager 334 may manage a log file and take log requests from the DTF 340, the graphical user interface, and the command line interface, and write the requests to the SCM log file. SCM configuration changes may include adding, modifying and deleting users and nodes in the SCM module 110, and creating, modifying and deleting node groups 132 and tools 240. An example of task execution events may include details and intermediate events associated with the running of a tool 240. An example of task execution is described in United States patent application of Lister, Sanchez, Drees, and Finz, Ser. No. 09/813,562, entitled “Service Control Manager Tool Execution”, and filed on Mar. 20, 2001, which is incorporated herein by reference. The details that are logged may include the identity of the user 210 who launched the task, the actual tool and command line with arguments, and the list of target nodes 130. The intermediate events that are logged may include the beginning of a task on a managed node 130, and exceptions that occur in attempting to run a tool 240 on a node 130, and the final result, if any, of the task. The exit code, standard output (stdout) and standard error output (stderr), if exist, may also be logged.

A security manager 332, which is a subsection of the domain manager 330, typically guards the system security by checking whether the user 210 is authorized to run the tool 240 on all of the nodes 130 requested, i.e., whether the user 210 is assigned the roles 220 associated with the tool 240 on all of the nodes 130, and whether the necessary roles 220 are enabled on a particular tool 240.

A tool 240 may be started in an SCM environment, which is the memory set aside for the tool 240 to look up attribute values. When launching MSA applications, the SCM environment may be extended to pass additional information by providing additional environment variables. For example, MX_USER is an environment variable that contains the login name of the user 210 executing the tool 240; MX_TASKID is an environment variable that contains the DTF task ID and uniquely names a tool execution instance; MX_TOOL is an environment variable that contains the name of the tool 240 that executed this specific executable; MX_TARGETS is an environment variable that contains the application's target node list for MSA applications, the list of node names may be space-delimited and sorted in a lexicographic order; MX_CMS is an environment variable that contains the host name of the CMS 100; and MX_REPOSITORY is an environment variable that contains the hostname of the system hosting the SCM repository 104. When a user 210 with authorization to nodes 1-5 launches a tool 240, the SCM determines an identity of the user and establishes environment variables that contain environment variable value pairs, so that only nodes 1-5 can be accessed by this user 210. Accordingly, the behavior of these applications is different when they run stand-alone and when they run in the SCM environment, where they have to follow the rules set by the SCM. If the user 210 tries to access resources outside that domain, the attempt will be blocked by the MSA tool 240 and an error message returned.

Applications maybe integrated into the SCM environment by creating an SCM tool 240 for them. This tool 240 may have a wrapper script that may process any input parameters and run the application. The application software may need to be pre-installed on the target nodes 130. Some applications may be distributed by nature and may be encapsulated in the distributed tool 240. When a task is executing on a node 130, the agent running on the node 130 may set the environment variables in the environment in which the tool command runs.

In a GUI, SCM integrated applications may be categorized, for example, based on the shade of blue that an application turns as it uses more and more of the SCM functionality. A deeper shade of blue may indicate more and more use of the SCM functionality. By implication, the darker shaded applications use most if not all of the functionality of a lighter shade application. Table 3 describes each shade.

TABLE 3

| | |
|---|---|
| Clear | These applications use none of the SCM functionality. |
| Light | These applications are moderately SCM aware, in that during |
| Blue | installation they detect the presence of a CMS. As part of |
| | their configuration they provide information to the SCM |
| | module and expose their set of tools to the SCM. |
| True Blue | These applications are not only SCM aware during |
| | installation, they are aware that when launched they can |
| | take advantage of the additional information passed to them |
| | by the SCM module. They may also make use of the SCM |
| | authorization model, and the SCM logging facility to |
| | ensure that their own application logging is integrated |
| | with the SCM and thus highly searchable. Likewise, True |
| | Blue applications adhere to the SCM GUI look and feel. |
| Deep Blue | These are the most highly integrated applications, that use |
| | the SCM data repository not only to acquire SCM specific |
| | information but also to store their own application |
| | specific information. |

Light Blue distributed applications may build command lines using the target environment variable.

True Blue applications are aware that when launched they are provided with additional start up information via the environment variables. Furthermore, True Blue applications may integrate their application logging into the SCM central log file, which may provide the added benefit of centralized logging. Likewise, end users 210 may take advantage of the SCM log file querying mechanism. Additionally, True Blue applications may take advantage of the SCM roles 220 by running application specific tools 240 under the guise of the user 210 identified in the MX_USER environment variable, assuming that the True Blue applications initiate their actions from the CMS 100.

Deep Blue applications may be the most tightly integrated because they have knowledge of the SCM data repository 104, its schema, and the directory structure. Deep Blue applications may read SCM user 210 and node 130 entries. They may extend the data repository 104 by complying with the directory layout structure and the schema extension rules, and storing their application specific data in their portion of the data repository 104.

SSA applications may only run on the node 130 that the applications reside. The procedure to launch SSA applications is similar to the procedure to launch MSA applications, which is described next.

MSA applications (tools) may run at the CMS 100 or an MSA managed node 130 other than the CMS 100. To launch the MSA applications and pass a specific list of remote target nodes 130, default targets may be established during tool definition to specify the target nodes 130 on which to the MSA applications should affect configuration changes. Alternatively, the target nodes 130 on which to execute the MSA applications may be selected by the user 210, in which case, the default targets may be ignored by the DTF 340. An example of tool definition is described in United States patent application of Lister, Sanchez, Drees, and Finz, Ser. No. 09/800,316, entitled “Service Control Manager Tool Definition”, and filed on Mar. 6, 2001, which is incorporated herein by reference.

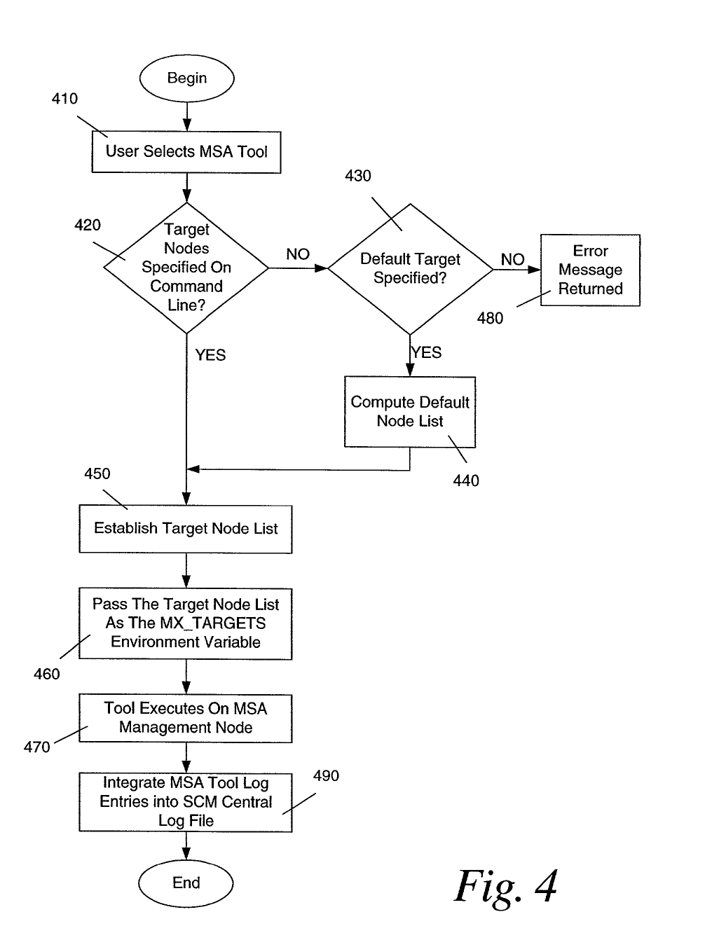

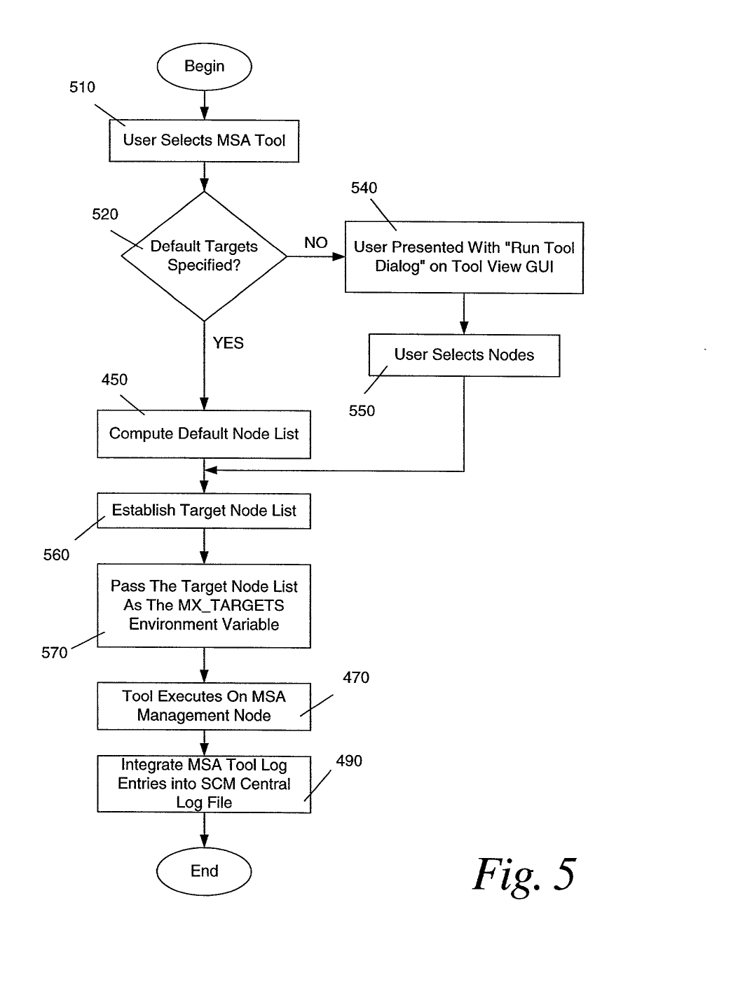

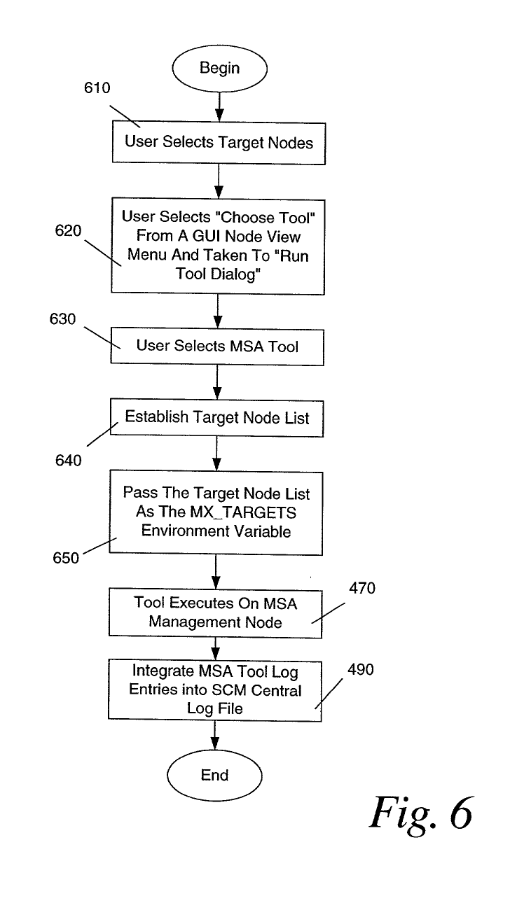

Tasks may be started by a user 210 using either the CLI or GUI. Using the GUI, there may be two different ways of executing tasks on a remote node 130, either from a tool view menu or from a node view menu. The tool view menu 360, shown in FIG. 3(b), provides a view of the tools 240 defined in the SCM cluster 140. The uppermost view is of tool categories 350, which are container objects, containing tools 240. Tools 240 may be assigned to a category 350 when created. When opened, the tools 240 in that category 350 may be displayed, and the user 210 can double-click on a tool 240 to execute it. The nodes view menu 370, shown in FIG. 3(c), provides a view of the SCM nodes 130 from which to initiate actions. A trusted user can see all the nodes 130 in the cluster 140, while other users 210 can only see and select the nodes on which they have authorizations. FIG. 4 illustrates a method for executing MSA applications in the SCM cluster 140 using the CLI, FIG. 5 illustrates a method for executing MSA applications using GUI from the tool view menu 360, and FIG. 6 illustrates a method for executing MSA applications using GUI from the node view menu 370. These methods may be implemented in, for example, software modules for execution by processor 108.

Referring to FIG. 4, from the CLI, a task may be started manually by typing a command, such as mxexec. The user then identifies on the mxexec command line an MSA tool 240 to run in the SCM environment, step 410. If the user 210 has specified the target nodes 130 to run the tool 240 on the command line, step 420, the mxexec CLI in the CMS 100 may establish a target node list that contains the user specified target nodes 130, and ignore any tool specified default targets, step 450. On the other hand, if the user 210 fails to specify the target nodes 130, the mxexec CLI may check whether there are default targets 130 specified, step 430. If yes, from the default targets 130, the mxexec CLI may compute a default target list that contains the nodes the user 210 is able to access, step 440, and a target node list may be established from the default node list, step 450. However, if there are no target nodes specified by the user 210, and no default targets 130 specified, the mxexec command line may return an error massage to the user 210, such as “need to specify a target”, step 480. After the target node list is established, the DTF 340 may pass the target node list as the MX₁₃ TARGETS environment variable, step 460. Now, the selected target or default target nodes 130 become the contents of the environment variable that may later be passed to the MSA tool 240. The MSA tool 240 may then be executed on the MSA managed node 130, and emanate to the nodes 130 in the target node list, step 470.

Finally, since SCM cluster configuration changes may be logged by the log manager 334 in an SCM central log file, while tool execution events may be logged in an MSA tool log file, the MSA tool log file may be integrated into the SCM central log file to provide the added benefit of centralized logging, step 490. Likewise, end users 210 may take advantage of the SCM log file querying mechanism.

As mentioned above, running an MSA tool in the SCM environment using the GUI may start from, for example, either the tool view menu 360 or the node view menu 370, the steps of which are described in FIGS. 5 and 6, respectively. Referring to FIG. 5, from the GUI tool view menu 360, a user 210 first selects an MSA tool 240, step 510. Next, the GUI checks whether there are default targets 130 specified in the tool definition, step 520. If yes, from the default targets 130, the GUI may compute a default target list that contains the nodes the user 210 is able to access, step 530, and a target node list may be established from the default node list, step 560. Conversely, if there are no default targets 130 specified, the user 210 may be presented with a “run tool dialog”, step 540, to manually select the target nodes 130 on which to run the tool 240, step 550. Then, similar to establishing a target node list from the default targets, the GUI may establish a target node list that contains the target nodes 130 selected by the user 210, step 560. After the target node list is established, the DTF 340 may pass the target node list as the MX_TARGET environment variable, step 570, so that the default target or the selected target nodes 130 become the contents of this environment variable that may later be passed to the MSA tool 240. The MSA tool 240 may then be executed on the MSA managed node 130, and emanate to the nodes 130 in the target node list, step 470. Finally, the MSA tool log file maybe integrated into the SCM central log file to provide added benefit of centralized logging, step 490.

From the node view menu 370, as processed by the method shown in FIG. 6, a user 210 first selects the desired target nodes 130 on which to run the tool 240, step 610. Then the user 210 is taken to a “run tool dialog” by selecting, for example, a “user choose tool” bar, step 620. From the “run tool dialog”, the user 210 may select an MSA tool 240, step 630, and the GUI in the CMS 100 may establish a target node list that contains the selected target nodes 130 from which the tool 240 may allow access to the user 210, step 640, and pass the target node list as the MX_TARGETS environment variable, step 650. Now, the selected target nodes 130 become the contents of this environment variable that may be passed to the MSA tool 240. The MSA tool 240 may then be executed on the MSA managed node 130, and emanate to the nodes 130 in the target node list, step 470. Finally, the MSA tool log file may be integrated into the SCM central log file to provide added benefit of centralized logging, step 490.

In summary, by setting up a single multi-system management environment, the SCM module 110 provides a simple method to integrate both SSA management applications and MSA management applications into the multi-system environment.

While the present invention has been described in connection with an exemplary embodiment, it will be understood that many modifications will be readily apparent to those skilled in the art, and this application is intended to cover any variations thereof.

What is claimed is:

1. A method for executing multi-system aware (MSA) applications in a cluster, comprising:
receiving selection of an MSA tool by a user;
establishing a target node list that contains nodes against which the MSA tool can execute;
passing the target node list as environment variables to the MSA tool; and
executing the MSA tool with the environment variables on an MSA managed node.

2. The method of claim 1, wherein the receiving step includes receiving selection of the MSA tool that launches system interactive applications.

3. The method of claim 1, wherein the establishing step includes establishing a target node list that contains node groups against which the MSA tool can execute.

4. The method of claim 1, wherein the establishing step includes computing a default target node list from default nodes specified.

5. The method of claim 1, wherein the passing step includes passing the target node list as target environment variables.

6. The method of claim 1, wherein the receiving step includes receiving selection of the MSA tool using a command line interface.

7. The method of claim 6, wherein the establishing step includes establishing the list from target nodes specified on the command line.

8. The method of claim 6, further comprising returning an error message if no target node is specified.

9. The method of claim 1, wherein the receiving step includes receiving selection of the MSA tool from a tool view menu using a graphical user interface.

10. The method of claim 9, wherein the establishing step includes receiving selection of target nodes by the user from a dialog in the tool view menu.

11. The method of claim 1, further comprising receiving selection of target nodes by the user from a node view menu using a graphical user interface.

12. The method of claim 11, wherein the receiving selection of the MSA tool step includes selecting the MSA tool by the user from a dialog in the node view menu.

13. The method of claim 1, further comprising:
logging cluster configuration changes in a central log file by a log manager;
logging tool execution events in an MSA tool log file; and
integrating the MSA tool log file into the central log file.

14. An apparatus for executing multi-system aware (MSA) applications in a cluster, comprising:
a module for receiving selection of an MSA tool by a user;
a module for establishing a target node list that contains nodes against which the MSA tool can execute;
a module for passing the target node list as environment variables to the MSA tool; and
a module for executing the MSA tool with the environment variables on an MSA managed node.

15. The apparatus of claim 14, wherein the module for establishing the target node list includes a module for computing a default target node list from default nodes specified.

16. The apparatus of claim 14, wherein the module for passing the target node list includes a module for passing the target node list as target environment variables.

17. The apparatus of claim 14, wherein the module for receiving selection of the MSA tool includes a module for receiving selection of the MSA tool using a command line interface.

18. The apparatus of claim 14, wherein the module for receiving selection of the MSA tool includes a module for receiving selection of the MSA tool from a tool view menu using a graphical user interface.

19. The apparatus of claim 14, further comprising a module for receiving selection of target nodes by the user from a node view menu using a graphical user interface.

20. A method for executing multi-system aware (MSA) applications in a cluster, comprising:
receiving selection of an MSA tool by a user using command line interface;
establishing a target node list that contains nodes against which the MSA tool can execution, wherein the list is established from default nodes or target nodes specified on the command line;
passing the target node list as target environment variables to the MSA tool;
executing the MSA tool with the environment variables on an MSA managed node;
logging cluster configuration changes in a central log file by a log manager;
logging tool execution events in an MSA tool log file; and
integrating the MSA tool log file into the central log file.
